(19) United States
(12) Patent Application Publication
(10) Pub. No.: US 2002/0192835 A1
(43) Pub. Date: Dec. 19, 2002

(54) Immunochromatographic assay strip and assay device having transparent plastic backing and method for producing the same

(75) Inventors: Min Cho, Anyang-city (KR); Yoo Deok Won, Yongin-si (KR); In Wook Kim, Seongnam-city (KR)

Correspondence Address: STAAS & HALSEY LLP, 700 11TH STREET, NW, SUITE 500, WASHINGTON, DC, 20001, US

(73) Assignee: KOREAN GREENCROSS CORPORATION, Kyonggi-Do (KR)

(21) Appl. No.: 10/097,400

(22) Filed: Mar. 15, 2002

(30) Foreign Application Priority Data
Jun. 15, 2001 (KR) 2001-0033780

(51) Int. Cl. G01N 21/77

(52) U.S. Cl. 436/170; 436/169; 422/55; 422/56

(57) ABSTRACT

The present invention discloses an immunochromatographic assay strip, and an assay device using the same. The assay strip includes a sample pad for receiving a liquid phase sample, a porous membrane pad having at least one reaction zone including a detecting substance to react with an analyte in the liquid phase sample, and a transparent plastic backing for supporting the sample pad and the porous membrane pad. The immunochromatographic assay device comprises the assay strip; an upper case including with a result observation window formed on the corresponding position of the reaction zone of the assay strip, and a sample receving hole formed on the corresponding position of the sample pad; and a lower case to be combined with the upper case, wherein the transparent backing of the assay strip is disposed between the upper case and the lower case to face the observation window of the upper case.

### FIELD OF THE INVENTION

The present invention relates to an immunochromatographic assay strip and an assay device. In particular, the present invention relates to an immunochromatographic assay strip having a transparent plastic backing on which assay components, such as a sample pad and a porous membrane pad, are serially arranged, an assay device, and a method for producing the same.

The transparent plastic backing for an assay strip according to the present invention connects and supports each pad, and allows a liquid sample to be tested to migrate from a sample pad to a porous membrane pad without interruption. Since the backing is made of a transparent material, one can check the assay results manifested on the porous membrane through the transparent backing. The present invention provides an immunochromatographic assay device in which the strip is mounted between an upper case having a sample receiving hole and an observation window of a test result, and a lower case corresponding to the upper case. In addition, the present invention provides a method of producing the immunochromatographic assay device, which comprises the steps of mounting the immunochromatographic assay strip comprising transparent plastic backing on the upper case to face the observation window of the upper case, and covering the lower case. In the immunochromatographic assay device according to an embodiment of the present invention, the upper case preferably includes a strip support for fixating the strip thereon.

### BACKGROUNDS OF THE INVENTION

The immunochromatographic assay known as “a rapid testing method” has been developed as a simple, qualitative and quantitative analysis method for a minute analyte, and the assay is applied in various fields such as a medical field for diagnosing diseases, agriculture, livestock raising, foods, military, environment and so on. The method is characterized of the short testing time of within 5 minutes, and its simplicity of operation.

The immunochromatographic assay is typically comprised of a single strip-shaped assay, or an assay device having the strip installed in a plastic case. The strip includes a sample pad for receiving the sample; a tracer pad containing a tracer made by conjugating a label to a ligand such as an antigen or an antibody, wherein the label generates a signal detectable by the naked eye or a sensor; a porous membrane immobilized with a first binding agent (an antigen or an antibody) for specifically combining with an analyte in the sample and a second binding agent (an antigen or an antibody) for detecting the tracer secondarily; and an absorbent pad for receiving a liquid phase sample finally.

In general assay strip, the aforementioned elements are consecutively arranged on the upper portion of an opaque plastic backing, overlapping with neighboring elements. The strip can be used by itself, or it can be used by being installed in a plastic case having an upper portion and a lower portion. The upper portion of the case includes the sample receiving hole for introducing the sample to the sample pad, and the result observation window for observing the test result manifested on the porous membrane pad. On the other hand, the lower portion of the case generally includes a plurality of supports for supporting the strip.

In most cases, the conventional assay strip is dipped into a test tube containing the liquid phase sample, and yields the test result after a certain period of time. In such case, because of the opaque plastic backing, user may check the test result from only one side of the strip, and have to turn the test tube around to see the result more clearly. In addition, the test result was often confused because the result line was not clear. This is partially due to the fact that the user could not see the result through a belt-side, which is more homogeneous than air side of the porous membrane attached to the backing.

In typical assay device having the above constitution, the liquid phase sample loaded through the sample receiving hole is migrated by a capillary action along the porous membrane where the actual analysis takes place, and most of water is migrated to the absorbent pad. Here, if the analyte in the sample has a high viscosity like a blood plasma, the water component is evaporated through the observation window that is formed on the upper portion of the plastic case, so the sample no longer flows and the test cannot be conducted further. In some case, the liquid sample absorbed to the absorbent pad flows backwards to sample pad, and the result line displayed on the porous membrane turned to unclear due to the counter flown water and tracer component, and as a result, the test result cannot be maintained for long time. Furthermore, the assay device has the same problem with the assay strip in that more clear or definite test results through the belt-side of the porous membrane are impossible to obtain.

In order to prevent water evaporation through the observation window during the test, and to protect the porous membrane from air contact for preserving the test result as long as possible, Yoshihito et al., (WO 00/77521) tried to cover the observation window with a transparent cover, and Lee-Won et al., (WO 94/24563) attached a transparent tape to the upper portion of porous membrane. Alternatively, U.S. Pat. No. 5,415,994 discloses another method for preventing the water evaporation, which attaches a piece of paper or plastic to the upper portion of the porous membrane in a form of the rail holder, and then attaches another transparent film as big as the result observation window on the upper portion of the holder. Unfortunately, such assay devices were expensive to manufacture, and required somewhat complicated manufacturing procedures.

In the meantime, many attempts have been made to solve the problems of the conventional assay strip of being unable to obtain better test results through the homogeneous belt-side, which is attached to the backing. For example, Yuhan Corporation (a company of Republic of Korea) manufactured assay device named ‘My Check’ without using any opaque plastic backing. The assay device includes a lower case installed with the components including serially a sample pad, a tracer pad, a porous membrane and an absorbent pad, wherein the belt-side of the porous membrane is installed to face the transparent observation window formed on the upper case. However, the manufacturer has to install each component of the assay strip onto a plastic case with a particular machine, or needs an automatic equipment therefor. Furthermore, there is no plastic backing to support the components, thus one should be very careful when handing the device.

### SUMMARY OF THE INVENTION

The inventors of the present invention realized that the above-mentioned problems were occurred because most of the skilled people in the art tried to examine the test result from the front side of the strip, which is opposite to the opaque plastic backing, and they designed the immunochromatographic assay strip just for this purpose. On the contrary, we could solve the problems by using a transparent plastic backing instead of the opaque plastic backing for the immunochromatographic assay strip in order to observe the test results through the transparent plastic backing in the rear side of the strip.

It is, therefore, an object of the present invention to provide an immunochromatographic assay strip for observing the test results from the front side as well as the rear side of the assay strip by using a transparent plastic backing.

Another object of the present invention is to provide an immunochromatographic assay device for preventing water evaporation through an observation window and for keeping the test results from being deteriorated, which consequently makes it possible to preserve the test result for an extended period of time, by installing a transparent backing of the strip to face the observation window formed on the upper case of the device.

Still another object of the present invention is to provide an immunochromatographic assay device and a method for producing the same, the device being easy to assemble and to manufacture by forming a guide to fixate the strip to the upper case of the device.

To achieve the above object, there is provided an immunochromatographic assay strip including a sample pad for receiving a liquid phase sample; a porous membrane pad having at least one reaction zone including a detecting substance to react with an analyte in the liquid phase sample; and a transparent plastic backing for supporting the sample pad and the porous membrane pad.

Another embodiment of the present invention provides an immunochromatographic assay device including an upper case having a result observation window at a position corresponding to the reaction zone of the assay strip, and a sample receiving hole at a position corresponding to the sample pad; a lower case to be combined with the upper case; and the assay strip disposed between the upper case and the lower case so that the a transparent backing of the strip is to face the observation window of the upper case. Here, the backing is preferably made of a material having rigidity and transparency selected from a group consisting of a transparent polyester film, a transparent polycarbonate film, a transparent acrylic film and so on. Preferably, sample pad and the porous membrane pad are attached to the transparent backing by a transparent binding agent.

Yet another aspect of the present invention provides a method for producing the immunochromatographic assay device, the method including the steps of: attaching the assay strip to the upper case of the device so that the transparent plastic backing of the assay strip is to face the result observation window; and combining the upper case with the corresponding lower case.

### BRIEF DESCRIPTION OF THE DRAWINGS

The above objects, features and advantages of the present invention will become more apparent from the following detailed description when considered in conjunction with the accompanying drawings, in which:

FIG. 1 is a perspective view of an immunochromatographic assay strip in an early stage of manufacture in accordance with a preferred embodiment of the present invention;

FIG. 2 is a perspective view of an individual assay strip according to an embodiment of the present invention cut along line A-A′ in FIG. 1;

FIG. 3 is a cross-sectional view of an assay strip according to an embodiment of the present invention as taken along line B-B′ in FIG. 2;

FIG. 4a is a plane view of an upper case of the immunochromatographic assay device according to another embodiment of the present invention;

FIG. 4b is a plane view of a lower case of the immunochromatographic assay device according to another embodiment of the present invention;

FIG. 5 is an exploded perspective view of the immunochromatographic assay device according to another embodiment of the present invention;

FIG. 6a and FIG. 6b are pictures showing a test result of a negative sample of a Hepatitis B surface antigen using the immunochromatographic assay device according to another embodiment of the present invention; and

FIG. 7a and FIG. 7b are pictures showing a test result of a positive sample of a Hepatitis B surface antigen using the immunochromatographic assay device according to another embodiment of the present invention.

### DETAILED DESCRIPTION OF THE PREFERRED EMBODIMENT

By way of example only, certain preferred embodiments of the present invention will now be described with reference to the accompanying drawings. In the following description, same drawing reference numerals are used for the same elements even in different drawings. The matters defined in the description are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

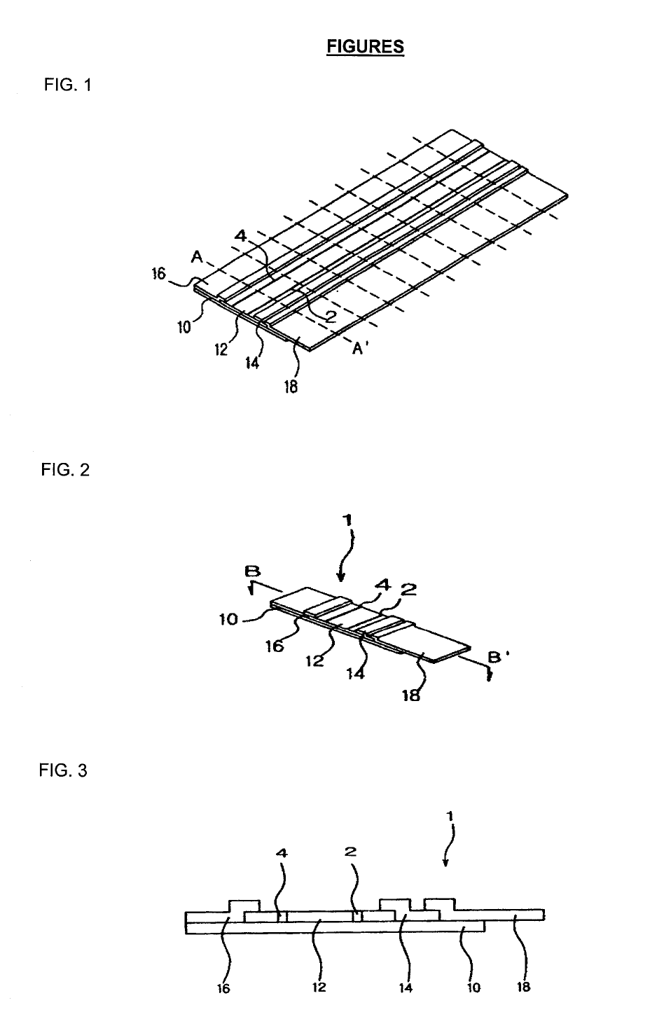

FIG. 1 is a perspective view of an immunochromatographic assay strip in an early stage of manufacture according to an embodiment of the present invention; FIG. 2 is a perspective view of an individual assay strip according to an embodiment of the present invention cut along line A-A′ in FIG. 1; and FIG. 3 is a cross-sectional view of an assay strip according to an embodiment of the present invention as taken along line B-B′ in FIG. 2.

As shown in the figures, the strip 1 includes a transparent backing 10. Preferably, one side of the transparent plastic backing 10 is coated with a colorless binding agent(not shown), and on the top of that, a porous membrane pad 12 on which a test line 2 is formed, and a sample pad 18 are attached. The backing 10 is preferably made of a material having rigidity and transparency selected from a group consisting of a transparent polyester film, a polycarbonate film, and an acrylic film.

The sample pad 18 is a place where a liquid phase sample containing an analyte is introduced, and the pad 18 is connected to the porous membrane pad 12 for the liquid phase sample to be able to migrate. The test line 2 of the porous membrane pad 12 is a reaction zone, being formed of a detecting substance to react with the analyte in the liquid phase sample. At least one test line 12 is formed on the porous membrane pad 12, and if necessary, a control line 4 can be formed at a certain distance from the test line 2. Further, the sample pad 18 can impregnate the tracer to react with the detecting substance, or the tracer can be disposed at a separate tracer pad 14 formed between the porous membrane pad 12 and the sample pad 18 according to the assay configuration. The tracer pad 14 contains a tracer-ligand complex such as gold colloid-antigen conjugate, and more preferably, the tracer pad 14 is attached to the porous membrane pad 12 and the sample pad 18 at its both ends, respectively. Most preferably, the tracer pad 14 overlaps with the porous membrane pad 12 and the sample pad 18 with the overlapping distance of 2 mm. In addition, an absorbent pad 16 can be formed at the other end of porous membrane pad 12 in such way that 2 mm of the absorbent pad 16 is overlapped with the porous membrane pad 12. At this time, the absorbent pad 16 can be placed to the end portion of the backing 10.

In general, when a sandwich type assay method is applied to the immunochromatographic assay, the liquid sample dropped on the sample pad 18 migrates to the tracer pad 14 by a capillary action, and the analyte in the sample and the ligand of the tracer undergo an immunologic reaction and produces an immune complex. The immune complex then migrates to the porous membrane pad 12 along with the sample flow, and is attached to the test line 2 where a first binding agent is immobilized, through an immunologic specific binding. On the other hand, if a competitive or inhibition assay method is applied, the test line 2, being composed of a binding agent reacts with the ligand of the tracer. Here, according to the various assay configuration, the binding agent can be the same substance with the analyte in the sample, the derivatives of the analyte, the same substance with the ligand of the tracer, or the derivatives of the ligand having the equivalent binding strength with the ligand.

Preferably, the tracer is positioned in the tracer pad 14 in freeze-dried state so that the tracer can be more easily migrated along with the liquid sample by a capillary action. In some assay configuration, the tracer includes a ligand and a label portion that generates a detectable signal. The ligand can be either an antigen that reacts with the analyte in the sample, or a specific antibody that binds with the analyte directly. Also, the tracer label can be a gold colloid generating a signal that is detectable through the naked eye or the sensor, a colored polystyrene micro particle known as latex, enzyme, fluorescent pigment, conducting polymer, or paramagnetic particle forming a magnetic field in a current field. Here, it is generally more desirable to use a combined ligand-e tracer label, rather than using the ligand and the tracer label separately. Alternatively, it is also possible to use tracer slurry formed with a gold colloid-antigen conjugate.

In case of the sandwich type assay, intensity of the signal generated by the label is proportional to the amount of the analyte in the sample. Thus, the existence of the analyte can be detected qualitatively, such as, “positive” or “negative”. Further, the intensity of the signal can be measured quantitatively by comparing the detected signal with the standard signal that colored with the standard substance, or with a standard colorimetry table. More precisely, depending on the nature of the signal generated by the label, the intensity of the signal can be measured quantitatively by using an appropriate optical sensor, electrochemical sensor, or a sensor that detects the conductivity change or magnetic field change. In the meantime, the quantity of the tracer that is captured by the immobilized binding agent in reaction zone is proportional to the quantity of the analyte in the sample. Thus, the quantity of the tracer that binds with the second binding agents in control line is inversely proportional to the quantity of the analyte. Therefore, by comparing the intensities of color produced by the tracers in the reaction zone and the control line, the concentration of the analyte in the sample can be also anticipated. As well-known, when the analyte is an antigen or a hapten, the binding agent to be bound with the analyte can be a monoclonal antibody or a polyclonal antibody thereof. Especially, if the analyte is an antibody, its binding agent can be a specific antigen which binds with the antibody.

As shown in FIGS. 1 through 3, when the tracer pad 14 is formed, the chemical and physical properties of the tracer pad 14 are usually different from the porous membrane pad 12 and the sample pad 18. In other cases, the tracer pad 14 does not have to be used separately, but the tracer can be positioned in the sample pad 18, and makes the sample pad 18 to work as the tracer pad 14. Since the tracer is directly attached to the binding agent in the porous membrane pad 12, or indirectly attached to the binding agent with analyte, the quantity of the tracer attached to the binding agent is proportional or inversely proportional to the amount of the analyte in the liquid phase sample. The porous membrane pad 12 is made of a material selected from a group consisting of nitrocellulose, glass fiber, polyethersulfone (PES), cellulose, and nylon. More preferably, nitrocellulose having the pores of diameter of 5-15 micrometer is appropriate for the porous membrane pad 12. The binding agents of the test line 2 formed on the porous membrane pad 12 should be immobilized on the pad 12 so as not to migrate along with the sample by a capillary action. The binding agents can be immobilized on the pad 12 by hydrophobic absorption, covalent coupling, or hydrogen bonding. The method for immobilizing the binding agent to the porous membrane pad 12 is well known in the art. The absorbent pad 16 is the place where the sample and the tracer that have been migrated from the porous pad 12 are finally received. Therefore, the size or capacity of the absorbent pad 16 should be controlled to prevent excessive liquid phase sample flow thereto.

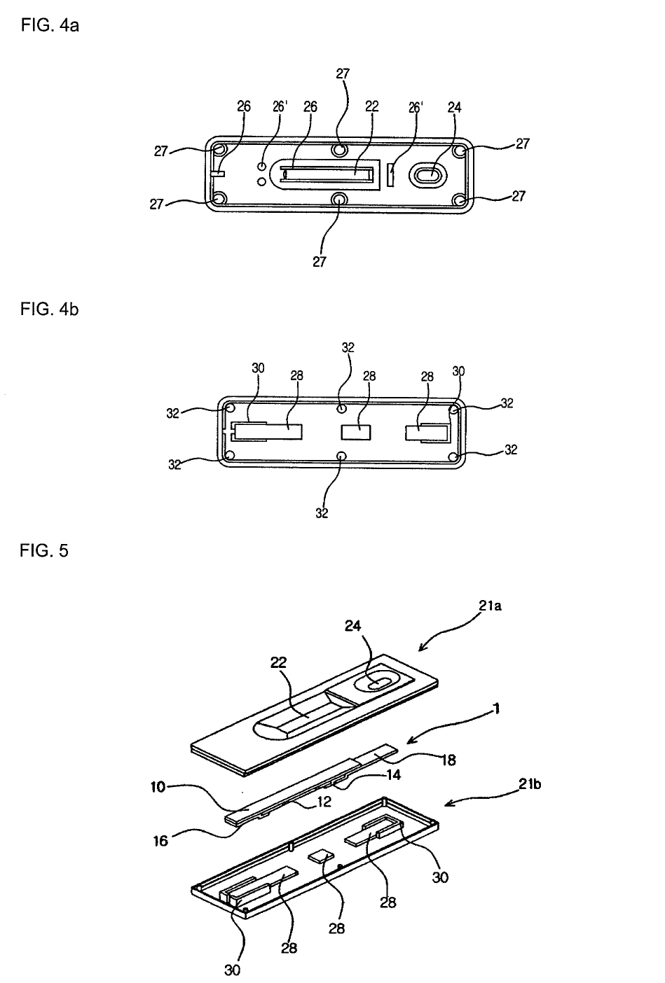

For preventing water evaporation and convenience of use, the assay strip can be installed between the upper case and the lower case of immunochromatographic assay device. FIG. 4a is a plane view of the upper case of the immunochromatographic assay device in accordance with an embodiment of the present invention. As shown in FIG. 4a, the upper case of the device according to an example of the present invention includes the sample receiving hole 24 disposed on the corresponding position of the sample pad 18 of the assay strip, and the observation window 22 disposed on the corresponding position of the test line 2 of the assay strip. In addition, in order to arrange or support the strip, the device can further include a plurality of guides 26, a plurality of projections 26 ′ for compressing the overlapping portions of the porous membrane pad 12, the sample pad 18 or the absorbent pad 16, and connecting apertures 27 for connecting the lower case.

FIG. 4b is a plane view of the lower case of the immunochromatographic assay device in accordance with an embodiment of the present invention. As shown in FIG. 4b, the lower case includes the supporters 28 to support the overlapped portion of the sample pad 18 and the tracer pad 14, the overlapped portion of the tracer pad 14 and the porous membrane 12, and the overlapped portion of the porous membrane 12 and the absorbent pad 16 that are consecutively arranged on the strip 1. Also, the lower case further includes the guides 30 for properly positioning and fixating the strips 1, and connecting protrusions 32 for connecting the upper case.

FIG. 5 is an exploded perspective view of the immunochromatographic assay device according to another embodiment of the present invention. As shown in FIG. 5, the strip 1 is installed between the upper case 21a and the lower case 21b in a manner that the transparent plastic backing 10 is to face upwards. Namely, the transparent plastic backing 10 is positioned to protect the sample which flows the porous membrane pad 12 from the outside air, and simultaneously, to display the reaction zone formed on the porous membrane pad 12 through the observation window 22 so that the result can be observed with naked eye. Preferably, the assay strip 1 is fixated to the upper case 21a. Also, the backing 10 should be very tightly sealed with the observation window 22 so as not to pass air and water.

Alternatively, the compression projections 26′ of the upper case 21a can be formed on the corresponding position of the lower case, and the guides 30 of the lower case 21b can be formed on the corresponding position of the upper case 21a. In that way, the device of the present invention can successfully prevent evaporation of the sample during test. At this time, it should be careful that a portion of the ending part of the sample pad 18 is not covered by the transparent plastic backing 10 so that sample can be introduced through the sample receiving hole 24. In other words, when the strip 1 of the present invention is installed in the device, the transparent plastic backing 10 faces to the direction of the sample receiving hole 24. Thus, if the ending part of the sample pad 18 is fully covered by the transparent plastic backing 10, the sample cannot be introduced to the sample pad 18 through the sample receiving hole 24. The assay strip of the present invention preferably makes each pad 12, 14, 16 and 18 to be overlapped each other on the transparent plastic backing 10. Besides, when the strip 1 is installed between the upper case and the lower case 21a and 21b, the transparent plastic backing 10 faces to upwards, namely, faces to the direction of the observation window 22, so that the transparent plastic backing 10 itself can be exposed to the outside through the observation window 22.

The present invention will now be explained in more detail with the following example, but the present invention is not limited to the scope of the following example.

### EXAMPLE

1. Manufacture of a Transparent Card Containing a Porous Membrane

A porous nitrocellulose membrane having a pore-size of 10-12 μm, and a migration speed of distilled water by a capillary action of 135±30 sec/4 cm was cut into pieces having the size of 25.4 mm x 270 mm. The used nitrocellulose membrane does not have a mylar backing, and has a belt side and an air side, which are differentiated according to the degree of smooth of the surface. First of all, the membrane was positioned so that the air side thereof is to face downwards, and a transparent backing having the size of 56 mm x 270 mm was attached to the membrane with a transparent adhesive. In detail, the membrane was attached 14 mm away from the top of the transparent backing and 16 mm away from the bottom of the transparent backing. In case that the nitrocellulose membrane is manufactured by injecting nitrocellulose on a mylar backing, the membrane was positioned so that the mylar backing thereof is to face downwards, and a transparent backing was attached to the membrane.

2. Manufacture of a Porous Thin Layer Assay Strip Immobilized with Antigen

Hepatitis B surface antigen was immunized to a goat to obtain an anti-hepatitis B surface antibody. The antibody was then diluted with 10 mM borate buffer solution, and the diluted antibody was spread over the test line of the nitrocellulose membrane with concentration of 1 μl/cm. The antibodies were dried in a 30° C. Thermostat to be immobilized. Similarly, an anti-mouth immunoglobulin G antibody was obtained by immunizing the goat with a mouth immunoglobulin G. The antibody was diluted with borate buffer solution. Then, the diluted antibody was spread over the control line of the nitrocellulose membrane with concentration of 1 μl/cm, and was dried in a 30° C. Thermostat to be immobilized. Then, phosphate buffer solution containing 5% of bovine serum albumin, 4% of sucrose, and 0.0625% of ionic surfactant was sprayed on the remaining nitrocellulose membrane, and the membrane was dried in the 30° C. Thermostat for 60-120 minutes.

3. Manufacture of a Tracer Slurry by Conjugating Gold Colloid with an Antibody

To 1 ml of gold colloid-water solution, added was an anti-hepatitis B surface antigen antibody with various concentration. Then, 150 mM sodium chloride solution corresponding to 1/10 of the volume of the gold colloid solution was added, and the minimal amount to stabilize gold colloid was determined. And, based on the determined ratio, the anti-hepatitis B surface antigen antibody was mixed with gold colloid solution, and the mixture was treated with 1% bovine serum albumin. The conjugated solution was centrifuged four times at 800 rpm, and the upper serum was removed. Later, 1% bovine serum albumin phosphate buffer solution was added again, and the absorbance of gold colloid conjugate was

4. Manufacture of a Tracer Pad

Obtained gold colloid-antibody conjugate solution was diluted with distilled water containing 0.5% sucrose until its absorbance becomes 2, and the diluted solution was sprayed over the glass fiber pad with a concentration of 10 μl/25 mm2. Then, the glass fiber pad coated with the gold colloid antibody conjugate solution was rapidly frozen with liquid nitrogen, and was freeze-dried in a freeze dryer for 20 hours. Finally, the freeze-dried pad was cut into pieces of the size of 4 mm x 270 mm.

5. Manufacture of an Assay Device

The tracer pad 14 including the gold colloid antibody conjugate was first disposed at 15 mm away from the bottom of the transparent plastic backing 10 on which the porous membrane 12 immobilized with the test line 2 and the control line 4 is disposed. The tracer pad 14 was positioned to overlap with the porous membrane pad 12 by 2 mm. Then, the sample pad 18 was attached to cover the bottom end of the plastic backing 10, and to overlap with the tracer pad 14, and the absorbent pad 16 was attached to cover the top end of the plastic backing 10, and to overlap the porous membrane 12. The produced laminated sheet was cut into pieces of 4 mm x 58 mm to manufacture the strip. Finally, by installing the strip in the case, the assay device was obtained.

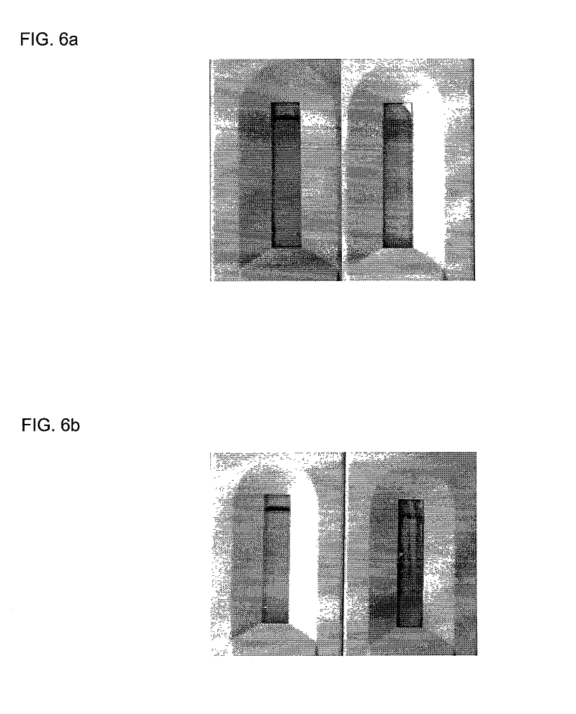

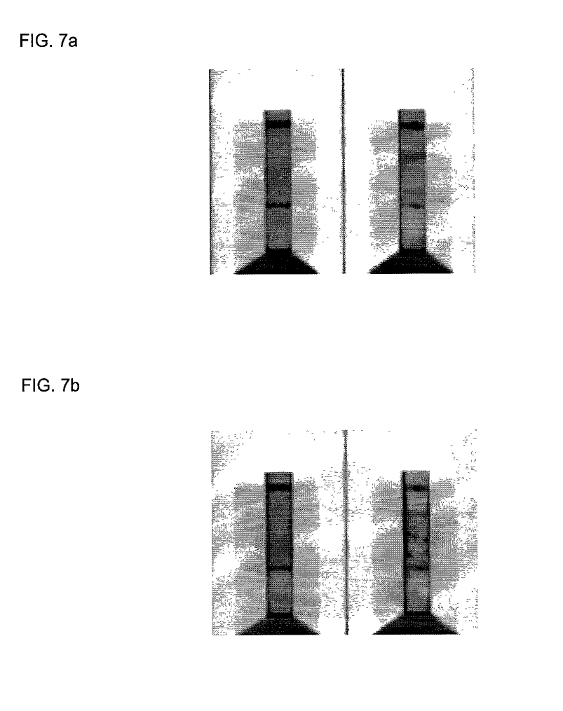

The assay device manufactured in accordance with the present invention was used for testing Hepatitis B surface antigen negative and positive sample, and the results are shown in FIGS. 6a and 6b, and FIGS. 7a and 7b, respectively. The pictures shown in FIG. 6a and FIG. 6b are taken 10 minutes and 30 minutes after the sample loading. In FIG. 6a and FIG. 6b, the left side photographs show the results obtained using the device according to an embodiment of the present invention, and the right side photographs show the results obtained using the conventional device, in which the porous membrane is exposed to the air through the observation window. As evidently shown in FIG. 6, if the device of the present invention is used, the reaction line color is still clear even 10 minutes or 30 minutes after the test. However, when the conventional device is used, the reaction line color gets dulled 30 minutes after the test. Similar results were obtained in case of testing Hepatitis B surface antigen positive sample (See FIGS. 7a and 7b).

In conclusion, the assay strip having the transparent plastic backing according to the present invention is very useful in that the test results can be detected through both front side and rear side of the strip. In addition, by observing the test results through the belt-side, which is the smooth side of the porous membrane attached to the mylar backing, better test results can be obtained with the strip of the present invention.

Further, in case of installing the strip inside of the device, a separate transparent film or plastic cover to keep the porous membrane from being exposed to the outside air through the observation window is not necessary. The device equipped with the strip according to the present invention can be manufactured very easily, and can successfully prevent any damage on the test results, and can preserve the results as long as possible.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An immunochromatographic assay strip comprising:
a sample pad for receiving a liquid phase sample;
a porous membrane pad having at least one reaction zone including a detecting substance to react with an analyte in the liquid phase sample; and
a transparent plastic backing for supporting the sample pad and the porous membrane pad.

2. The assay strip according to claim 1, wherein the backing is made of a material having rigidity and transparency selected from a group consisting of a transparent polyester film, a transparent polycarbonate film, and a transparent acrylic film.

3. The assay strip according to claim 1, wherein the sample pad further comprises a tracer reacting with the analyte in the sample.

4. The assay strip according to claim 1, further comprising an absorbent pad which is installed on a top end of the porous membrane pad for absorbing the liquid phase sample migrated from the sample pad.

5. The assay strip according to claim 1, further comprising a tracer pad disposed between the sample pad and the porous membrane pad, the tracer pad including a tracer reacting with the analyte in the sample.

6. An immunochromatographic assay device comprising:
an assay strip including a sample pad for receiving a liquid phase sample, a porous membrane pad having at least one reaction zone including a detecting substance to react with an analyte in the liquid phase sample, and a transparent plastic backing for supporting the sample pad and the porous membrane pad;
an upper case including an observation window formed on the corresponding position of the reaction zone of the assay strip, and a sample receiving hole formed on the corresponding position of the sample pad; and
a lower case to be combined with the upper case,
wherein the transparent backing of the assay strip is disposed between the upper case and the lower case to face the observation window of the upper case

7. The assay device according to claim 6, wherein the assay strip is fixated in the upper case.

8. The assay device according to claim 6, wherein the assay strip is fixated by a plurality of guides formed in the upper case.

9. The assay device according to claim 6, wherein the backing is formed on the sample pad to partially expose the sample pad through the sample receiving hole.

10. A method for producing an immunochromatographic assay device, the method comprising the steps of:
attaching an assay strip to the upper case of the device, wherein the assay strip is comprised of a sample pad for receiving a liquid phase sample, a porous membrane pad having at least one reaction zone including a detecting substance to react with an analyte in the liquid phase sample, and a transparent plastic backing for supporting the sample pad and the porous membrane pad, and the transparent plastic backing of the assay strip is positioned to face the result observation window; and
combining the upper case and the corresponding lower case.
